(19) United States
(12) Patent Application Publication
(10) Pub. No.: US 2008/0186418 A1
(43) Pub. Date: Aug. 7, 2008

(54) Display device

(75) Inventors: Seong-ho Kim, Yongin-si (KR); Young-jin Chang, Yongin-si (KR); Jae-beom Choi, Suwon-si (KR); In-do Chung, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/012,249

(22) Filed: Jan. 31, 2008

(30) Foreign Application Priority Data
Feb. 2, 2007 (KR) 10-2007-0011107

(51) Int. Cl. G02F 1/1335

(52) U.S. Cl. 349/12; 349/96

(57) ABSTRACT

A display device includes: a first insulating substrate; a first polarizing plate formed on an external surface of the first insulating substrate; a second insulating substrate coupled to the first insulating substrate; a liquid crystal layer interposed between the first insulating substrate and the second insulating substrate; a first resistive film formed on an external surface of the second insulating substrate; a second polarizing plate positioned on the first resistive film; a supporting film positioned on an internal surface of the second polarizing plate and having isotropic property; a second resistive film formed on the supporting film and facing the first resistive film; and a diffusion layer interposed between the second insulating substrate and the second polarizing plate.

### CROSS-REFERENCE TO RELATED APPLICATIONS

This application claims priority from Korean Patent Application No. 10-2007-0011107, filed on Feb. 2, 2007 in the Korean Intellectual Property Office, the disclosure of which is incorporated herein by reference.

### BACKGROUND

1. Field of Invention

Apparatuses consistent with the present invention relate to a display device, and more particularly, to a display device with a touch screen.

2. Description of the Related Art

As image display devices, a cathode ray tube (CRT), a liquid crystal display (LCD) device, a plasma display panel (PDP), an organic light emitting diode (OLED) and the like have been widely used.

Recently, in such image display devices, a touch screen element as an input device has been introduced.

In such an image display device, when a user presses a surface of a touch screen element using his/her finger or a pen, information corresponding to the pressed position of the touch screen is displayed on the image display device.

A pair of resistive layers facing with each other is provided on a touch screen element. The pressed position is detected by contact between the resistive layers so that one of the resistive layers is formed on a flexible film for deformation during pressing.

However, in case of a display device with a touch screen element, there is a problem that Newton's rings may occur due to interference between the insulating substrate of the image display device and a flexible film of the touch screen panel so that display quality deteriorates.

### SUMMARY OF THE INVENTION

Accordingly, it is an aspect of the present invention to provide a display device reducing Newton's rings.

Additional aspects of the present invention will be set forth in the description which follows.

The foregoing and/or other aspects of the present invention can be achieved by providing a display device comprising: a first insulating substrate; a first polarizing plate formed on an external surface of the first insulating substrate; a second insulating substrate coupled to the first insulating substrate; a liquid crystal layer interposed between the first insulating substrate and the second insulating substrate; a first resistive film formed on an external surface of the second insulating substrate; a second polarizing plate positioned on the first resistive film; a supporting film positioned on an internal surface of the second polarizing plate and having isotropic property; a second resistive film formed on the supporting film and facing the first resistive film; and a diffusion layer interposed between the second insulating substrate and the second polarizing plate.

In an embodiment of the disclosure, the diffusion layer includes a base resin and silica particles scattered in the base resin.

In an embodiment of the disclosure, the base resin includes acryl resin.

In an embodiment of the disclosure, the diffusion layer is interposed between the supporting film and the second resistive film.

In an embodiment of the disclosure, a haze value of the diffusion layer ranges from 7% to 10%.

In an embodiment of the disclosure, the diffusion layer includes a first diffusion layer interposed between the supporting film and the second resistive film, and a second diffusion layer interposed between the second insulating substrate and the first resistive film.

In an embodiment of the disclosure, the sum of haze values of the first diffusion layer and the second diffusion layer ranges from 7% to 10%.

In an embodiment of the disclosure, the display device further comprises an anti-reflection layer interposed between the second insulating substrate and the second polarizing plate.

In an embodiment of the disclosure, the anti-reflection layer is interposed between the supporting film and the second resistive film.

In an embodiment of the disclosure, the display device further comprises an adhesive layer interposed between the second insulating substrate and the supporting film.

In an embodiment of the disclosure, the display device further comprises a spacer disposed between the first resistive film and the second resistive film

The foregoing and/or other aspects of the present invention can be achieved by providing a display device comprising: a liquid crystal display panel including a first insulating substrate formed with a thin film transistor, a second insulating substrate coupled to the first insulating substrate, and a liquid crystal layer interposed therebetween; a first polarizing plate attached to an external surface of the first insulating substrate; a touch screen element positioned on an external surface of the second insulating substrate and including a diffusion layer; and a second polarizing plate formed on the touch screen element.

In an embodiment of the disclosure, the touch screen element includes a supporting film having isotropic property.

In an embodiment of the disclosure, the touch screen element further comprises a first resistive film formed on an external surface of the second insulating substrate, and a second resistive film formed on the supporting film and facing the first resistive film.

In an embodiment of the disclosure, the diffusion layer includes a base resin and silica particles scattered in the base resin.

In an embodiment of the disclosure, the base resin includes acryl resin.

In an embodiment of the disclosure, the diffusion layer is interposed between the supporting film and the second resistive film.

In an embodiment of the disclosure, a haze value of the diffusion layer ranges from 7% to 10%.

In an embodiment of the disclosure, the diffusion layer includes a first diffusion layer interposed between the supporting film and the second resistive film, and a second diffusion layer interposed between the second insulating substrate and the first resistive film.

In an embodiment of the disclosure, the sum of haze values of the first diffusion layer and the second diffusion layer ranges from 7% to 10%.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a cross sectional view of a display device according to a first exemplary embodiment of the present disclosure;

FIG. 2 is an enlarged view of “A” in FIG. 1;

FIGS. 3 and 4 are diagrams for explaining a signal line structure of a touch screen element;

FIG. 5 is a cross sectional view of a display device according to a second exemplary embodiment of the present disclosure; and

FIG. 6 is a cross sectional view of a display device according to a third exemplary embodiment of the present disclosure.

### DETAILED DESCRIPTION

Reference will now be made in detail to the embodiments of the present disclosure, examples of which are illustrated in the accompanying drawings, wherein like reference numerals refer to like elements throughout. The embodiments are described below so as to explain the present disclosure by referring to the figures.

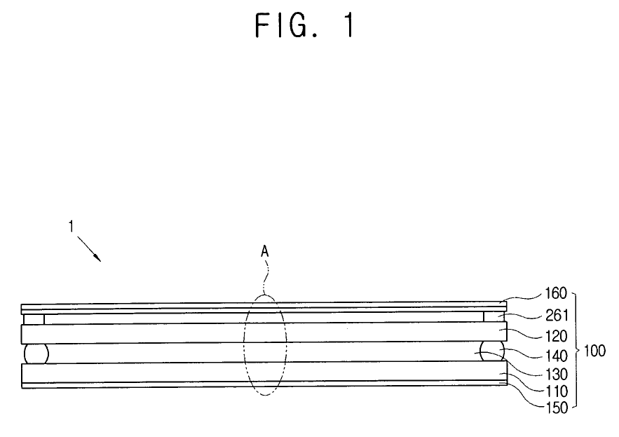

The first embodiment of the present disclosure will be described in more detail with reference to FIGS. 1 through 4.

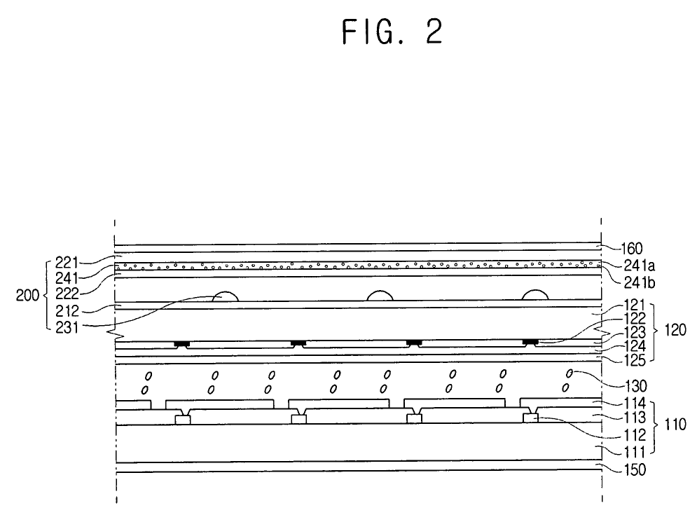

Referring to FIGS. 1 and 2, a display device 1 includes a liquid crystal display panel 100, and a touch screen element 200. The touch screen element 200 is formed between a second insulating substrate 121 and a second polarizing plate 160.

The liquid crystal display panel 100 includes a first substrate 110, a second substrate 120 facing the first substrate 110, a liquid crystal layer 130 interposed between both substrates 110 and 120, a sealant 140 positioned along boundaries of both substrates 110 and 120 for binding both substrates 110 and 120, a first polarizing plate 150 attached to the first substrate 110, and a second polarizing plate 160 positioned on the touch screen element 200.

The first substrate 110 includes a first insulating substrate 111, a thin film transistor 112, an insulating film 113, and a pixel electrode 114.

The first insulating substrate 111 may be made of glass or plastic materials. The pixel electrode 115 is plurally provided, each of which is electrically connected to a respective thin film transistor 112.

The second substrate 120 includes a second insulating substrate 121, a black matrix 122, a color filter 123, an overcoat layer 124, and a common electrode 125.

The second insulating substrate 121 may be made of glass or plastic materials. The black matrix 122 is formed to correspond to the thin film transistor 112. The color filter 123 includes a plurality of sub layers having different colors, for example, red, green, and blue. The common electrode 125 is formed across the second insulating substrate 121.

The pixel electrode 114 and the common electrode 125 include a transparent conductive material such as indium tin oxide (ITO), indium zinc oxide (IZO), or the like.

The liquid crystal layer 130 adjusts transmittance by changing orientation states of liquid crystal molecules under the influence of an electric field formed between the pixel electrode 114 and the common electrode 125.

The first polarizing plate 150 is attached to the external surface of the first insulating substrate 111 through an adhesive (not shown). The first polarizing plate 150 includes a polarizing layer controlling a polarizing state of incident light, and supporting layers positioned on an upper surface and a lower surface of the polarizing layer. The polarizing layer is formed, for example, by heating and stretching a thin film of poly vinyl alcohol (PVA), and dipping it into an iodic acid solution. The supporting layer includes triacetyl cellulose (TAC) or the like, and not only prevents the stretched polarizing layer from contraction but also protects and supports the polarizing layer. The second polarizing plate 160 has the same structure as the first polarizing plate 150, and thus will not be described in like detail.

The display device 1 may further include a back light unit (not shown) in the rear of the liquid crystal display panel 100.

The touch screen element 200 includes a first resistive film 212 formed on an exterior surface of the second insulating substrate 121, a supporting film 221 formed on an interior surface of the second polarizing plate 160, a second resistive film 222 facing the first resistive film 212, a diffusion layer 241 interposed between the supporting film 221 and the second resistive film 222, a spacer 231 formed on the first resistive film 212, and an adhesive layer (not shown) adhering the second insulating substrate 121 and the supporting film 221.

The first resistive film 212 is formed on most exterior surface of the second insulating substrate 121, and includes a transparent conductive material such as indium tin oxide (ITO), indium zinc oxide (IZO) or the like.

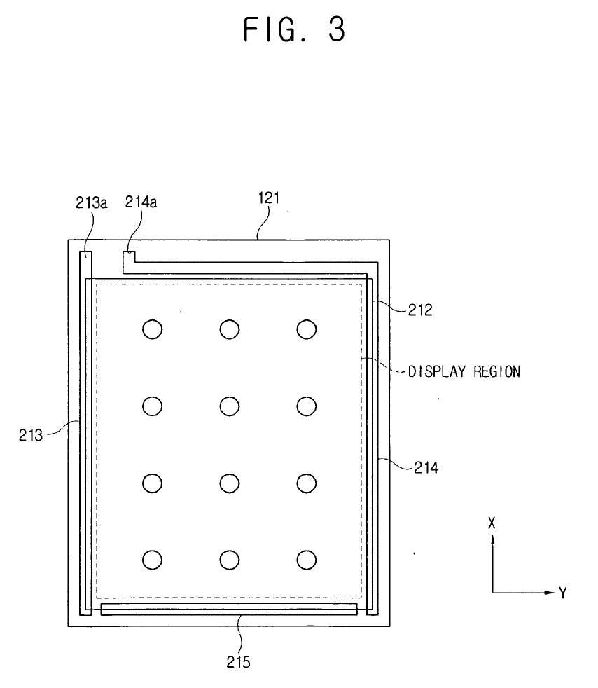

Referring to FIG. 3, signal lines 213 and 214 and a dummy signal line 215 are formed on the second insulating substrate 121.

The first signal line 213 and the second signal line 214 face each other with the first resistive film 212 interposed therebetween, and are extended along a longitudinal side of the second insulating substrate 121. The first signal line 213 and the second signal line 214 are extended in X direction so that they are referred to as X signal lines.

The first signal line 213 and the second signal line 214 are electrically connected with the first resistive film 212, and are made of metallic material.

An end portion of the first signal line 213 is a first pad 213a, and an end portion of the second signal line 214 is a second pad 214a. The first pad 213a and the second pad 214a are adjacent to each other.

The dummy signal line 215 is provided in the same layer as the signal lines 213 and 214, and keeps a constant space between the second insulating substrate 121 and the supporting film 221.

The supporting film 221 supports the second resistive film 222, and is interposed between the liquid crystal layer 130 and the second polarizing plate 160. Since light passing through the liquid crystal layer 130 should be introduced to the second polarizing plate 160 without changing the polarizing state produced therebetween, the supporting film 221 is an isotropic film.

The isotropic film is non-stretched film, and may be formed by extrusion, coating method, or the like. In use of the coating method, the isotropic film is formed by pouring resin solution into a mold and evaporating solvent from the resin solution.

The supporting film 221 is attached to an interior surface of the second polarizing plate 160. Although it is not shown, an adhesive layer may be interposed between the supporting film 221 and the second polarizing plate 160.

The supporting film 221 may include poly carbonate or polyethylene sulfone. Zeonor Film® manufactured by Nippon Zeon Co., ltd may be used as the supporting film 221.

The diffusion layer 241 is formed on the supporting film 221, and its structure and functions will be described later.

The second resistive film 222 is formed on the diffusion layer 241, and formed across the diffusion layer 241 to correspond to the first resistive film 212. The second resistive film 222 includes a transparent conductive material such as indium tin oxide (ITO), indium zinc oxide (IZO), or the like. Resistances of the first resistive film 212 and the second resistive film 222 may range from 400Ω/□ to 900Ω/□.

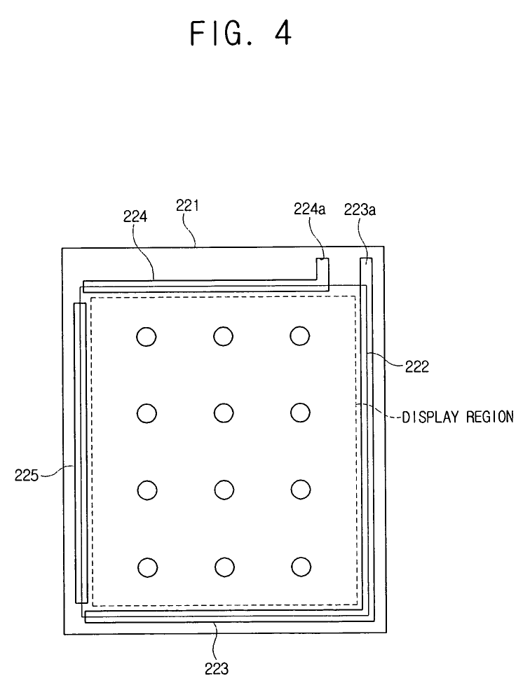

As shown in FIG. 4, a third signal line 223 and a fourth signal line 224 are formed on the supporting film 221. Referring to the coordinate system shown in FIG. 3, the third signal line 223 and the fourth signal line 224 are extended in Y direction so that they are referred to as Y signal lines. The third signal line 223 and the fourth signal line 224 are electrically connected with the second resistive film 222, and are made of metallic material.

An end portion of the third signal line 223 is a third pad 223a, and an end portion of the fourth signal line 224 is a fourth pad 224a. The third pad 223a and the fourth pad 224a are adjacent to each other.

A dummy signal line 225 is provided in the same layer as the signal lines 223 and 224, and keeps a constant space between the second insulating substrate 121 and the supporting film 221.

Although it is not shown, the display device 1 further includes a flexible circuit board electrically connected with each of the pads 213a, 214a, 223a, and 224a.

A spacer 231 with a hemisphere shape is positioned on the first resistive film 212.

The supporting film 221 supporting the second resistive film 222 is likely to deform towards the first resistive film 212 due to gravity force or the like. If the supporting film 221 is deformed, both resistive films 212 and 222 are short-circuited, which generates a problem that position where a user presses is hardly detected. The spacer 231 prevents both resistive films from directly contacting with each other even if the supporting film 221 is deformed.

The spacer 231 is formed by screen printing or printing using ultraviolet curing material, heat curing material, or the like.

The adhesive layer 261 is positioned along boundaries of the touch screen element 200 and attaches the supporting film 221 to the second insulating substrates 121. The adhesive layer 261 may be double sided tapes.

When the second polarizing plate 160 of the touch screen element 100 is pressed by a pen or a finger, the supporting film 221 is deformed. After the first resistive film 212 and the second resistive film 222 contact with each other by the deformation of the supporting film 221, a resistance value is changed according to the contacting position.

Current and/or voltage is changed as the resistance value is changed. The changed current and/or voltage is outputted through the pads 213a, 214a, 223a, and 224a.

In the foregoing display device 1, light passing through the liquid crystal layer 130 travels via the second insulating substrate 121 and the supporting film 221. At this time, Newton's rings may be generated by interference between the second insulating substrate 121 and the supporting film 221.

In this embodiment, the diffusion layer 241 prevents Newton's rings from generating. The diffusion layer 241 includes a base resin 241a and silica particles 241b scattered in the base resin 241a. The base resin 241a may include acryl resin.

The diffusion layer 241 may be formed by mixing silica with the acryl resin solution, and then, coating on the supporting film 221, and evaporating solvent of the acryl resin solution.

As light passing through the liquid crystal layer 130 travels via the diffusion layer 241, it collides with the silica particles 241b. The light colliding with the silica particles 241b is scattered and generates destructive interference so that Newton's rings are decreased.

A haze value of the diffusion layer 241 may be adjusted by changing a content of the silica particles 241b. For example, the haze value may range from 7% to 10%.

If the haze value of the diffusion layer 241 is less than 7%, it is not possible to efficiently reduce Newton's rings. On the contrary, if the haze value of the diffusion layer 241 is equal to and more than 10%, it causes a problem that light scattering increases so that a black brightness becomes higher. When the black brightness is higher, a contrast ratio is lower so that display quality deteriorates.

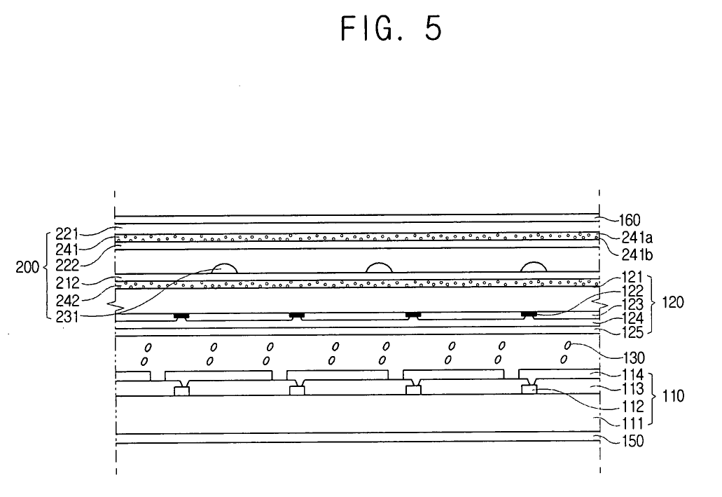

Referring to FIG. 5, a second embodiment of the present disclosure is described below.

According to the second embodiment of the present disclosure, the diffusion layers 241 and 242 include a first diffusion layer 241 interposed between the supporting film 221 and the second resistive film 222 and a second diffusion layer 242 interposed between the second insulating substrate 121 and the first resistive film 212.

A sum of haze values of the first diffusion layer 241 and the second diffusion layer 242 may range from 7% to 10%.

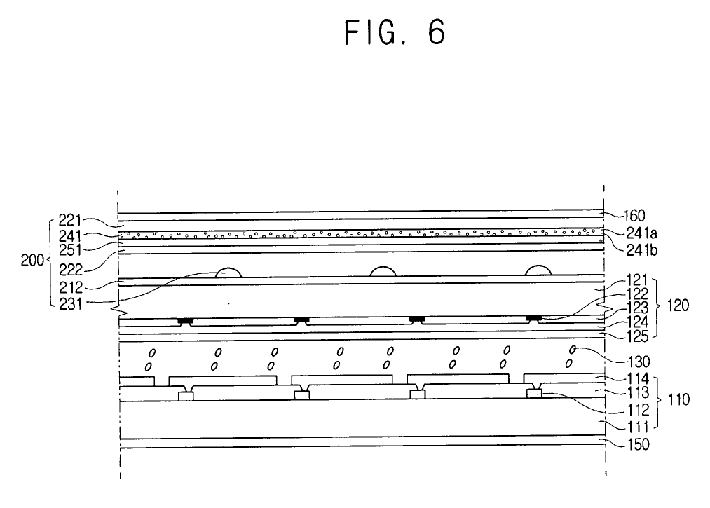

Referring to FIG. 6, a third embodiment of the present disclosure is described below.

According to the third embodiment of the present disclosure, a touch screen element 200 includes an anti-reflection layer 251.

The anti-reflection layer 251 is interposed between the diffusion layer 241 and the second resistive layer 222 and includes repetitively deposited silica layers and titanium oxide layers.

The anti-reflection layer 251 improves a transmittance of the second resistive film 222.

As described above, the present disclosure provides a display device decreased in Newton's rings.

Although a few exemplary embodiments of the present disclosure have been shown and described, it will be appreciated by those skilled in the art that changes may be made in these embodiments without departing from the principles and spirit of the disclosure, the scope of which is defined in the appended claims and their equivalents.

What is claimed is:

1. A display device comprising:
a first insulating substrate;
a first polarizing plate formed on an external surface of the first insulating substrate;
a second insulating substrate coupled to the first insulating substrate;
a liquid crystal layer interposed between the first insulating substrate and the second insulating substrate;
a first resistive film formed on an external surface of the second insulating substrate;
a second polarizing plate positioned on the first resistive film;
a supporting film positioned on an internal surface of the second polarizing plate and having isotropic property;
a second resistive film formed on the supporting film and facing the first resistive film; and
a diffusion layer interposed between the second insulating substrate and the second polarizing plate.

2. The display device according to claim 1, wherein the diffusion layer includes a base resin and silica particles scattered in the base resin.

3. The display device according to claim 2, wherein the base resin includes acryl resin.

4. The display device according to claim 1, wherein the diffusion layer is interposed between the supporting film and the second resistive film.

5. The display device according to claim 4, wherein a haze value of the diffusion layer ranges from 7% to 10%.

6. The display device according to claim 1, wherein the diffusion layer includes a first diffusion layer interposed between the supporting film and the second resistive film, and a second diffusion layer interposed between the second insulating substrate and the first resistive film.

7. The display device according to claim 6, wherein the sum of haze values of the first diffusion layer and the second diffusion layer ranges from 7% to 10%.

8. The display device according to claim 1, further comprising an anti-reflection layer interposed between the second insulating substrate and the second polarizing plate.

9. The display device according to claim 8, wherein the anti-reflection layer is interposed between the supporting film and the second resistive film.

10. The display device according to claim 1, further comprising an adhesive layer interposed between the second insulating substrate and the supporting film.

11. The display device according to claim 1, further comprising a spacer disposed between the first resistive film and the second resistive film.

12. A display device comprising:
a liquid crystal display panel including a first insulating substrate formed with a thin film transistor, a second insulating substrate coupled to the first insulating substrate, and a liquid crystal layer interposed therebetween;
a first polarizing plate attached to an external surface of the first insulating substrate;
a touch screen element positioned on an external surface of the second insulating substrate and including a diffusion layer; and
a second polarizing plate formed on the touch screen element.

13. The display device according to claim 12, wherein the touch screen element includes a supporting film having isotropic property.

14. The display device according to claim 13, wherein the touch screen element further comprises a first resistive film formed on an external surface of the second insulating substrate, and a second resistive film formed on the supporting film and facing the first resistive film.

15. The display device according to claim 12, wherein the diffusion layer includes a base resin and silica particles scattered in the base resin.

16. The display device according to claim 15, wherein the base resin includes acryl resin.

17. The display device according to claim 12, wherein the diffusion layer is interposed between the supporting film and the second resistive film.

18. The display device according to claim 17, wherein a haze value of the diffusion layer ranges from 7% to 10%.

19. The display device according to claim 12, wherein the diffusion layer includes a first diffusion layer interposed between the supporting film and the second resistive film, and a second diffusion layer interposed between the second insulating substrate and the first resistive film.

20. The display device according to claim 19, wherein the sum of haze values of the first diffusion layer and the second diffusion layer ranges from 7% to 10%.
